(19) United States
(12) Patent Application Publication
(10) Pub. No.: US 2025/0330206 A1
(43) Pub. Date: Oct. 23, 2025

(54) WIRELESS MULTI-USER COMMUNICATIONS SYSTEMS USING BLIND SOURCE SEPARATION

(71) Applicant: Analog Devices, Inc., Wilmington, MA (US)

(72) Inventors: Hsun-Wei Cho, Ann Arbor, MI (US); Kevin Chuang, Belmont, MA (US); Muhammad Saad Zia, Wilmington, MA (US); Weite Zhang, Watertown, MA (US)

(21) Appl. No.: 18/641,957

(22) Filed: Apr. 22, 2024

(51) Int. Cl. H04B 1/16; H04B 1/18; H04B 7/06

(52) U.S. Cl. CPC H04B 1/1638; H04B 1/18; H04B 7/0634

(57) ABSTRACT

Wireless communications systems using blind source separation are disclosed. In certain embodiments, a wireless communications system includes a digital front end (DFE) that processes two or more input signals received from the wireless communications system's antennas. The input signals reflect a mixture of transmitted signals (which can have a common frequency) received over a wireless channel from transmitting devices. The DFE applies an adjustable weight matrix to the received input signals to generate output signals corresponding to estimates of the transmitted signals from each of the transmitting devices. The DFE determines coefficients of the adjustable weight matrix using blind source separation in which the coefficients of the matrix are iteratively adjusted based on computations performed on the input signals, such as by utilizing an independent component analysis (ICA) technique. The embedded DFE system enables a multimodal communication experience by simultaneously supporting and running different stacks of inhomogeneous wireless standards.

### FIELD OF THE DISCLOSURE

Embodiments of the invention relate to electronic systems, and more particularly, to wireless communications systems.

### BACKGROUND

Wireless communications systems communicate radio frequency (RF) signals over wireless channels or links within a wireless network.

In one example, in a cellular network user equipment (UE) transmits to the network's base stations (for example, gNodeB/eNodeB) over uplink channels while the base stations transmit to the UE over downlink channels. The uplink and downlink channels can be associated with various frequency bands and can be duplexed in a variety of ways, such as using time-division duplexing (TDD) and/or frequency-division duplexing (FDD).

In other examples, wireless networks include, but are not limited to, Wi-Fi networks, Internet of Things (IoT) networks, frequency modulation (FM) networks, ad-hoc networks, as well as wireless networks using other proprietary and non-proprietary communications standards,

Examples of wireless communications devices include, but are not limited to, base stations, mobile devices (for instance, smartphones or handsets), laptop computers, tablets, and wearable electronics.

### SUMMARY OF THE DISCLOSURE

Wireless communications systems using blind source separation are disclosed. In certain embodiments, a wireless communications system includes a digital front end (DFE) that processes two or more input signals received from the wireless communications system's antennas. The input signals reflect a mixture of transmitted signals (which can have a common frequency) received over a wireless channel from transmitting devices. The DFE applies an adjustable weight matrix to the received input signals to generate output signals corresponding to estimates of the transmitted signals from each of the transmitting devices. The DFE determines coefficients of the adjustable weight matrix using blind source separation in which the coefficients of the matrix are iteratively adjusted based on computations performed on the input signals, such as by utilizing an independent component analysis (ICA) technique.

By using blind source separation, multiple wireless devices can communicate using the same frequency sub-carriers, but without requiring channel state information (CSI) to be exchanged. Such a feature eliminates a need for channel sounding, thus reducing excessive contention overhead at the medium access control (MAC) layer and reducing the overhead of the physical (PHY) layer preamble. This in turn leads to a significant improvement in spectral efficiency, latency, and/or device power consumption. Furthermore, the embedded DFE system enables a multimodal communication experience by simultaneously supporting and running different stacks of inhomogeneous wireless standards. Thus, blind source separation allows signals to be more effectively communicated and recovered in a wireless network. Such techniques can be particularly beneficial to address the ever-increasing number of connected devices in varying applications, including for a massive machine type communication (mMTC) application associated with providing connectivity to a massive number of wireless-enabled machines, devices, and sensors.

In one aspect, a wireless communications system includes a plurality of antennas configured to receive a plurality of radio frequency (RF) signals, the plurality of RF signals including a mixture of two or more transmitted signals received over a wireless channel from two or more transmitting devices. The wireless communications system further includes a digital front end (DFE) configured to receive a plurality of input signals corresponding to digital representations of the plurality of RF signals, wherein the DFE applies an adjustable weight matrix to the plurality of input signals to generate a plurality of output signals corresponding to estimates of the two or more transmitted signals, the DFE configured to determine a plurality of coefficients of the adjustable weight matrix by performing a blind source separation.

In another aspect, a digital front end (DFE) for a wireless communications system includes a data pre-processor configured to receive a plurality of input signals corresponding to digital representations of a plurality of RF signals, the plurality of RF signals including a mixture of two or more transmitted signals received over a wireless channel from two or more transmitting devices, the data pre-processor configured to process the plurality of input signals to generate a pre-whitened input signal matrix. The DFE further includes an estimator configured to determine a plurality of coefficients of an adjustable weight matrix based on the pre-whitened input signal matrix, and an actuator configured to apply the adjustable weight matrix to the pre-whitened input signal matrix to generate a plurality of output signals corresponding to estimates of the two or more transmitted signals.

In another aspect, a method of wireless communications includes receiving a plurality of radio frequency (RF) signals on a plurality of antennas of a wireless communications system, the plurality of RF signals including a mixture of two or more transmitted signals received over a wireless channel from two or more transmitting devices. The method further includes processing the plurality of RF signals to generate a plurality of received signals corresponding to digital representations of the plurality of RF signals using a transceiver of the wireless communications system, determining a plurality of coefficients of an adjustable weight matrix by performing a blind source separation using a digital front end (DFE) of the wireless communications system, and applying the adjustable weight matrix to the plurality of received signals to generate a plurality of output signals using the DFE, the plurality of output signals corresponding to estimates of the two or more transmitted signals.

### BRIEF DESCRIPTION OF THE DRAWINGS

FIG. 1 is a schematic diagram of one embodiment of a wireless communications receiver system.

FIG. 2 is a schematic diagram of another embodiment of a wireless communications receiver system.

FIG. 3 is a schematic diagram of another embodiment of a wireless communications receiver system.

FIG. 4 is a schematic diagram of one embodiment of a signal processing slice for a front end of a wireless communications system.

FIG. 5 is a schematic diagram of one embodiment of wireless communications network using blind source separation.

FIG. 6A is a schematic diagram of one embodiment of a digital front end (DFE) for a wireless communications system.

FIG. 6B is a schematic diagram of another embodiment of a DFE for a wireless communications system.

FIG. 7A is a graph of various examples of simulations of packet error rate (PER) versus receiver signal-to-noise ratio (SNR).

FIG. 7B is a graph of various examples of simulations of error vector magnitude (EVM) versus received SNR.

### DETAILED DESCRIPTION OF EMBODIMENTS

The following detailed description of embodiments presents various descriptions of specific embodiments of the invention. However, the invention can be embodied in a multitude of different ways. In this description, reference is made to the drawings. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

Channel estimation can be used in wireless networks to determine properties of the network's channels. For example, channel estimation can be used to obtain channel state information (CSI) that estimates how a wireless signal (also referred to as an RF signal or radio wave) propagates from the transmitter to the receiver in the presence of effects such as scattering, fading, interference, and/or attenuation. By estimating the channel, wireless communications systems can adapt transmission parameters (for instance, modulation scheme and/or transmit power) to achieve high data rates and/or reliable communications.

CSI can be obtained in wireless networks using various channel sounding techniques. For example, in certain cellular applications, sounding reference signals (SRS) are used in which the UE transmits reference signals to a base station (for example, eNodeB/gNodeB) that analyzes the received reference signals to estimate the channel. In another example, channel state information reference signaling (CSI-RS) is used in which a base station transmits a known reference signal to UE, and measures feedback from the UE to estimate channel characteristics. SRS and CSI-RS may be scheduled as desired in a cellular network, for instance, periodically, semi-persistently, and/or aperiodically.

Although channel sounding can effectively estimate channel characteristics in certain scenarios, channel sounding suffers from several challenges. For example, channel sounding has high latency and thus is not suitable for high mobility applications. Additionally, channel sounding can be limited by the transmit power capability of the UE and/or the antennas of the UE (for instance, the UE may have fewer transmit antennas relative to receive antennas). Furthermore, the channel may not be reciprocal between transmit and receive directions, and thus channel sounding may inaccurately estimate the channel's characteristics. Moreover, advanced network features, such as carrier aggregation can exacerbate these challenges by requiring more channels to sound.

Certain wireless networks suffer from transmit concurrency issues associated with multiple wireless devices transmitting on a common frequency at the same time. For example, certain cellular networks grant one UE a connection per network time slot, and simultaneous requests from additional UE for random access channel (RACH) are addressed using future times slots through contention resolution management.

Although contention resolution management can be suitable in some scenarios for addressing transmit concurrency, it is desirable to provide an efficient multi-user multiple-input multiple-output (MU-MIMO) framework.

Wireless communications systems using blind source separation are disclosed herein. In certain embodiments, the receiver of a wireless communications system includes a digital front end (DFE) that processes two or more input signals received from the wireless communications system's receiving antennas. The input signals reflect a mixture of transmitted signals (which can have a common frequency) received over a wireless channel from transmitting devices. The DFE applies an adjustable weight matrix to the received input signals to generate output signals corresponding to estimates of the transmitted signals from each of the transmitting devices. The DFE determines coefficients of the adjustable weight matrix using blind source separation in which the coefficients of the matrix are iteratively adjusted based on computations on the input signals, such as using an independent component analysis (ICA).

By using blind source separation, multiple wireless devices (for example, UE) can communicate using the same frequency sub-carriers, but without requiring CSI to be exchanged. Such a feature eliminates a need for channel sounding (for example, SRS and/or CSI-RS), thus reducing excessive contention overhead at the medium access control (MAC) layer and reducing the overhead of the physical (PHY) layer preamble. This in turn leads to a significant improvement in spectral efficiency, latency, and/or device power consumption.

Thus, blind source separation allows signals to be more effectively communicated and recovered in a wireless network. Such techniques can be particularly beneficial to address the ever-increasing number of connected devices in varying applications, including for a massive machine type communication (mMTC) application associated with providing connectivity to a massive number of wireless-enabled machines, devices, and sensors.

For example, blind source separation achieves more efficient MIMO operation for mMTC applications by avoiding the computational overhead associated with transmit channel precoding and/or receive channel estimation. Thus, blind source separation allows efficient MIMO operation for mMTC applications without interfering with other features of the mMTC network, such as low power consumption, extended coverage, device diversity, scalability, and/or agile deployment.

Other example applications for a DFE using blind source separation include aerospace, defense, and/or avionics. For example, blind source separation can be used to separate intended communications from jammer signals, including in applications in which an intelligent adversary utilizes a jammer signal to mock similar waveform characteristics as intended RF receive signals. Further applications for a DFE using blind source separation include, but are not limited to, recovery of multiple simultaneous frequency modulation (FM) transmissions and/or recovery of multiple simultaneous narrow band Internet of Things (NB-IoT) transmissions.

Accordingly, the DFE employing blind source separation techniques can be used for estimating transmitted signals associated with a variety of communication standards, including, but not limited to, Global System for Mobile Communications (GSM), Enhanced Data Rates for GSM Evolution (EDGE), Code Division Multiple Access (CDMA), wideband CDMA (W-CDMA), 3G, Long Term Evolution (LTE), 4G, 5G, 6G, IEEE 802.11 (Wi-Fi), IoT (including NB-IoT), FM, as well as other proprietary and non-proprietary communications standards, provisioning a future wireless network to accommodate diverse use cases.

Furthermore, the received signals that are separated using blind source separation can be transmitted to a wireless communications system over a wide range of frequencies, including not only RF signals between 100 MHz and 7 GHZ, but also to higher frequencies, such as those in the X band (about 7 GHz to 12 GHZ), the Kᵤ band (about 12 GHZ to 18 GHZ), the K band (about 18 GHz to 27 GHz), the Kₐ band (about 27 GHz to 40 GHZ), the V band (about 40 GHz to 75 GHZ), and/or the W band (about 75 GHz to 110 GHZ). Accordingly, the teachings herein are applicable to a wide variety of wireless communications systems, including microwave, millimeter-wave, and/or sub-terra hertz (sub-THz) communications systems.

Example Wireless Communications Systems with Blind Source Separation

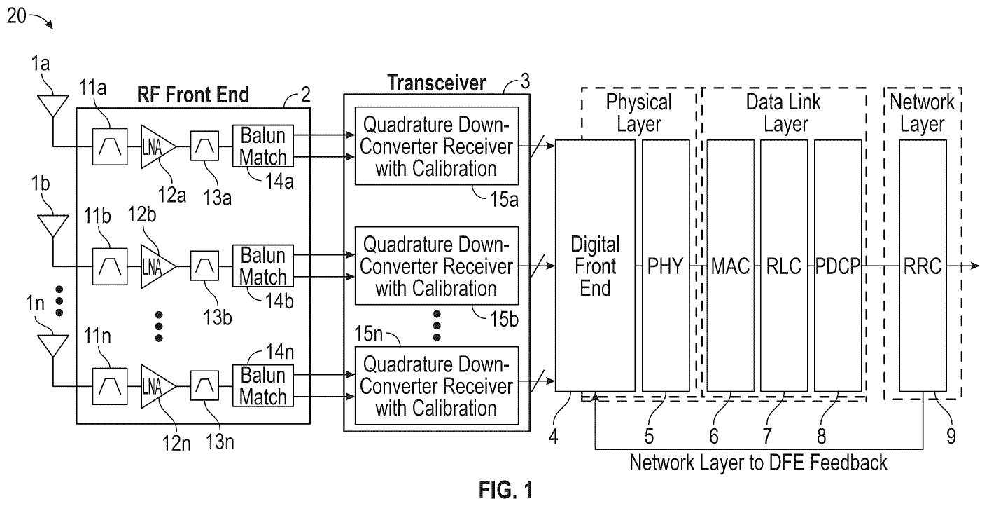

FIG. 1 is a schematic diagram of one embodiment of a wireless communications receiver system 20. The wireless communications receiver system 20 includes antennas 1a, 1b, . . . 1n, an RF front end 2, a transceiver 3, a digital front end (DFE) 4, a PHY block 5, a MAC block 6, a radio link control (RLC) block 7, a package data convergence protocol (PDCP) block 8, and a radio resource control (RRC) block 9.

The wireless communications receiver system 20 of FIG. 1 illustrates one example of a wireless communications receiver system that can include a DFE using blind source separation in accordance with one or more embodiments of the present disclosure. However, a DFE that uses blind source separation can be included in other implementations of wireless communications receiver systems. Accordingly, the teachings herein are applicable to other implementations of wireless communications receiver systems, such as those that include different implementations of antennas, RF front ends, transceivers, and/or other components.

In the illustrated embodiment, the RF front end 2 receives RF receive signals from the antennas 1a, 1b, . . . 1n. Although three antennas are illustrated, the wireless communications receiver system 20 can include any number n antennas as indicated by the ellipses. Furthermore, in certain implementations, the antennas 1a, 1b, . . . 1n are implemented as antenna arrays that each include two or more antenna elements that operate using beamforming or other techniques to receive RF signals.

With continuing reference to FIG. 1, the RF front end 2 includes antenna filters 11a, 11b, . . . 11n, low-noise amplifiers (LNAs) 12a, 12b, . . . 12n, receive filters 13a, 13b, . . . 13n, and balun match circuits 14a, 14b, . . . 14n. The antenna filters 11a, 11b, . . . 11n filter received RF signals from the antenna 1a, 1b, . . . 1n, respectively, to generate filtered RF signals that are provided to the LNAs 12a, 12b, . . . 12n for amplification. Additionally, the receive filters 13a, 13b, . . . 13n filter the amplified RF signals from the LNAs 12a, 12b, . . . 12n, respectively, and provide the filtered and amplified RF signals to the balun match circuits 14a, 14b, . . . 14n for single-ended to differential signal conversion (using baluns with impedance matching, in this example).

Although example components for processing received RF signals are depicted in the RF front end 2, the teachings herein are applicable to other implementations of RF front ends. Furthermore, although FIG. 1 depicts example circuitry for processing received RF signals, the RF front end 2 can also include any suitable circuitry for processing RF signals for transmission and/or for observing transmitted RF signals to aid in providing feedback for power control, digital pre-distortion (DPD), and/or other desired processing.

In the illustrated embodiment, the transceiver 3 includes quadrature down-converter receivers 15a, 15b, . . . 15n for processing differential received RF signals from the RF front end 2. In this example, the quadrature down-converter receivers 15a, 15b, . . . 15n operate with calibration to address receiver impairments including, for example, in-phase/quadrature-phase (I/Q) imbalances, non-linearities, offsets, and/or other non-idealities.

Although example receiver circuitry is depicted in the transceiver 3, the teachings herein are applicable to other implementations of transceivers. For example, a transceiver can be implemented with other types of receivers aside from quadrature down-converter receivers, including, but not limited to, direct RF sampling receivers. Additionally, quadrature down-converter receivers can be implemented in other ways. Furthermore, the transceiver 3 can include transmitter circuitry for generating RF signals for transmission as well as observation receiver circuitry for processing observation signals from the RF front end 2.

As shown in FIG. 1, the DFE 4 processes the received input signals from the transceiver 3. The received input signals correspond to a digital representation of each RF signal received from the antennas 1a, 1b, . . . 1n. The received input signals reflect a mixture of transmitted signals (which can have a common frequency) received over a wireless channel from transmitting devices (not shown in FIG. 1).

The DFE 4 can be implemented to provide blind source separation in accordance with one or more features of the present disclosure to determine estimates of the transmitted signals from each of the transmitting devices. By implementing the DFE 4 with blind source separation, MU-MIMO processing is provided at the DFE level. Furthermore, such processing can be achieved with little to no protocol overhead.

Although FIG. 1 depicts an example embodiment of a system that can include a DFE implemented in accordance with the teachings herein, a DFE that uses blind source separation can be included in other implementations of wireless communications receiver systems.

As shown in FIG. 1, the DFE 4 is coupled to the PHY block 5 to provide physical layer processing. Additionally, data link layer processing is provided by the MAC block 6, the RLC block 7, and the PDCP block 8, while network layer processing is provided by the RRC block 9. The physical layer, the data link layer, and the network layer can be associated with a cellular protocol stack, such as a 4G, 5G or 6G protocol stack. However, other implementations of wireless communications receiver systems are possible.

The DFE 4 resides between the data converters of the transceiver 3 and the PHY layer. From PHY, it can perform signal resampling to a higher data rate, e.g., carrier aggregation, signals filtering, and/or signals conditioning, prior to interfacing the data converter. In certain implementations, blind source separation is provided between the signal filtering and signals conditioning in the data path.

In the illustrated embodiment, the RRC block 9 provides feedback to the DFE 4. Providing feedback from a higher network layer can improve blind source separation processing, such as aiding the DFE 4 in determining the number of transmitting devices that are transmitting RF signals to the wireless communications receiver system 20 and/or to take corrective action against data corruption. However, the teachings herein are also applicable to implementations in which feedback to the DFE 4 is omitted. For instance, in another example corrective action against data corruption is performed by a signal quality check at the I/Q level.

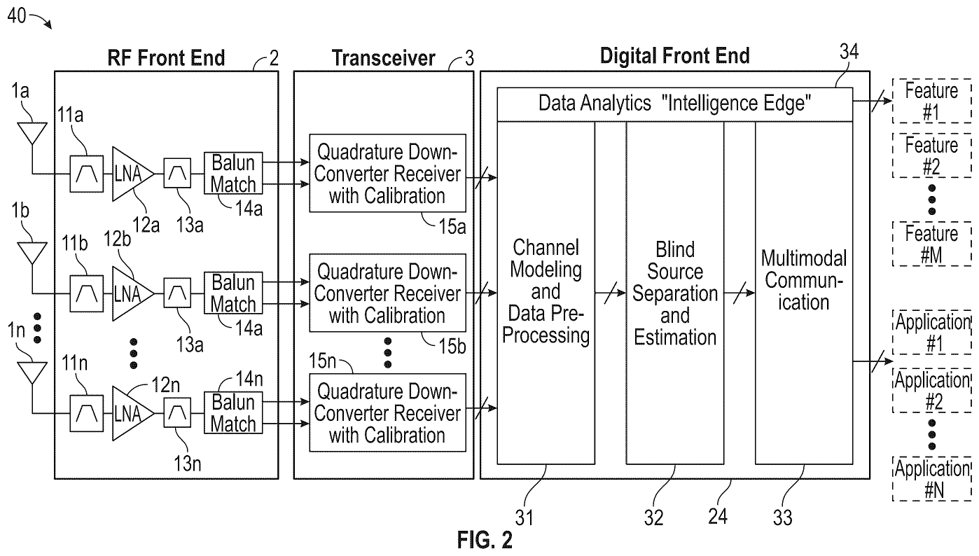

FIG. 2 is a schematic diagram of another embodiment of a wireless communications receiver system 40. The wireless communications receiver system 40 includes antennas 1a, 1b, . . . 1n, an RF front end 2, a transceiver 3, and a DFE 24.

The wireless communications receiver system 40 of FIG. 2 is similar to the wireless communications receiver system 20 of FIG. 1, except that the wireless communications receiver system 40 includes a specific implementation of the DFE 24. As shown in FIG. 2, the DFE 24 includes a channel modeling and data pre-processing block or module 31, a blind source separation and estimation module 32, a multimodal communication module 33, and a data analytics module 34. Although not shown in FIG. 2, the DFE 24 can be coupled to one or more downstream processing blocks, such as those associated with a physical layer, a datalink layer, and/or a network layer.

In the illustrated embodiment, the channel modeling and data pre-processing module 31 receives digital input signals from the transceiver 3. Each digital input signal is a digital representation of a corresponding RF signal received from the antennas 1a, 1b, . . . 1n. The channel modeling and data pre-processing module 31 can provide a wide variety of functions, such as equalizing and/or signal pre-whitening. In certain implementations, the channel modeling and data pre-processing module 31 provides equalization for a frequency selective wireless communication channel but operates without providing equalization for a flat fading wireless communication channel.

Such equalization can be linear, nonlinear, and/or trained by an artificial intelligence model (AI-trained model) and can be performed prior to applying blind source separation algorithms as desired.

With continuing reference to FIG. 2, the blind source separation and estimation module 32 serves to provide blind source separation in accordance with one or more of the embodiments herein. The blind source separation can be used to recover estimates of RF signals transmitted from one or more transmitting devices.

As shown in FIG. 2, the recovered output signals from the blind source separation and estimation module 32 are processed by the multi-modal communication module 33 to determine application data (associated with one or more applications #1, #2, . . . #N). The multi-modal communication module 33 can be used to recover signals from different transmitting devices of the same wireless standard (for instance, each with different numerologies) as well as from different wireless standards.

In the illustrated embodiment, the data analytics module 34 is coupled to one or more of the channel modeling and data pre-processing module 31, the blind source separation and estimation module 32, and/or the multimodal communication module 33. The data analytics module 34 provides an intelligence edge by obtaining feature data (which can be associated with one or more features #1, #2, . . . #M). The feature data can indicate a variety of features, such as channel propagation characteristics, RF signal characteristics or parameters, and/or concurrency (for instance, to enable listen before talking).

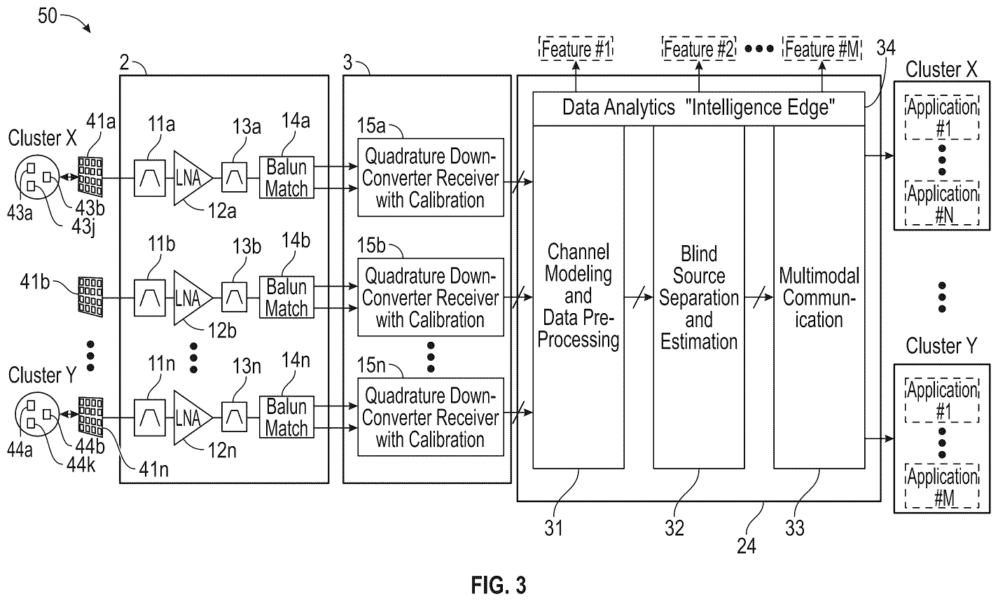

FIG. 3 is a schematic diagram of another embodiment of a wireless communications receiver system 50. The wireless communications receiver system 50 includes antenna arrays 41a, 41b, . . . 41n, an RF front end 2, a transceiver 3, and a DFE 24.

The wireless communications receiver system 50 of FIG. 3 is similar to the wireless communications receiver system 40 of FIG. 2, except that the wireless communications receiver system 50 includes antenna arrays 41a, 41b, . . . 41n for receiving RF signals associated with different user clusters. The antenna arrays 41a, 41b, . . . 41n can correspond to multiple antenna elements and associated beamformers for controlling a direction of a received signal beam.

The user clusters can be observed and separated in the spatial domain. In the depicted example, the antenna array 41a receives signals from a cluster X associated with devices 43a, 43b, . . . 43j, while the antenna array 41n receives signals from a cluster Y associated with devices 44a, 44b, . . . 44k.

Thus, blind source separation can be applied to different groupings of user clusters by employing analog beamformers at the antenna level, thereby improving communication capacity.

As shown in FIG. 3, the DFE 24 generates application data for cluster X (associated with one or more applications #1, . . . #N) as well as application data for cluster Y (associated with one or more applications #1, . . . #M).

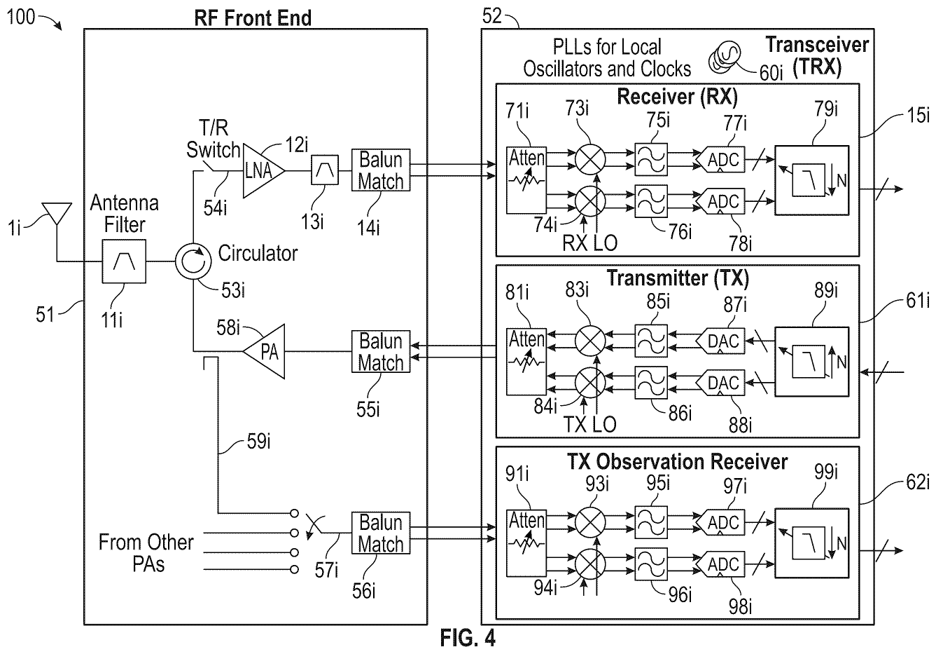

FIG. 4 is a schematic diagram of one embodiment of a signal processing slice 100 for a front end of a wireless communications system. The signal processing slice 100 includes an antenna 1i as well as portions of an RF front end 51 and a transceiver 52. Two or more such signal processing slices can be used to process data associated with multiple antennas or antenna arrays.

Although FIG. 4 depicts one example of a signal processing slice, DFEs can provide blind source separation to signals received from other implementations of signal processing slices. According, other implementations of signal processing slices are possible.

In the illustrated embodiment, the portion of the RF front end 51 includes an antenna filter 11i, a circulator 53i, a transmit/receive (T/R) switch 54i, an LNA 12i, a receive filter 13i, a receive balun match 14i, a power amplifier 58i, a transmit balun match 55i, an observation balun match 56i, an observation switch 57i, and a directional coupler 59i.

With continuing reference to FIG. 4, the portion of the transceiver 52 includes phase-locked loops (PLLs) 60i, a receiver 15i, a transmitter 61i, and an observation receiver 62i. Additionally, the receiver 15i includes a receive attenuator 71i, an I-path downconverting mixer 73i, an I-path receive filter 75i, an I-path analog-to-digital converter (ADC) 77i, a Q-path downconverting mixer 74i, a Q-path receive filter 76i, a Q-path ADC 78i, and a receive I/Q processor 79i.

As shown in FIG. 4, the transmitter 61i includes a transmit attenuator 81i, an I-path upconverting mixer 83i, an I-path transmit filter 85i, an I-path digital-to-analog converter (DAC) 87i, a Q-path upconverting mixer 84i, a Q-path transmit filter 86i, a Q-path DAC 88i, and a transmit I/Q processor 89i.

In the illustrated embodiment, the observation receiver 62i includes an observation attenuator 91i, an I-path observation mixer 93i, an I-path observation filter 95i, an I-path observation ADC 97i, a Q-path observation mixer 94i, a Q-path observation filter 96i, a Q-path observation ADC 98i, and an observation I/Q processor 99i.

The signal processing slice 100 corresponds to an example slice of an RF and baseband signal chain suitable for receiving an RF signal, transmitting an RF signal, and observing the transmitted RF signal. However, signal processing slices can be implemented in other ways.

As shown in FIG. 4, the circulator 53i includes an antenna port coupled to the antenna 1i through the antenna filter 11i, a transmit port coupled to an output of the power amplifier 58i, and a receive port coupled to an input of the LNA 12i through the T/R switch 54i. The amplified RF receive signal from the LNA 12i is provided to the receiver 15i by way of the receive filter 13i and the receive balun match 14i. Additionally, the power amplifier 58 receives an RF transmit signal from the transmitter 61i by way of the transmit balun match 55i. Furthermore, the directional coupler 58i generates an RF observation signal by sensing an amplified RF transmit signal at the output of the power amplifier 58i, and provides the RF observation signal to the observation receiver 62i by way of the observation switch 57i (for selecting a desired RF observation signal from a particular power amplifier) and the observation balun match 56i.

With continuing reference to FIG. 4, the receive attenuator 71i provides a desired attenuation to the received RF signal and provides the attenuated RF signal to the I-path and the Q-path of the receiver 15i. The receiver 15i includes the I-path downconverting mixer 73i and the Q-path downconverting mixer 74i which operate to provide frequency downconversion to the attenuated RF signal using quadrature receive local oscillator (RX LO) clock signals from the PLLs 60i. The downconverted I and Q signals are filtered by the receive filters 75i/76i and thereafter digitized by the ADCs 77i/78i. The digital I and Q receive signals are processed by the receive I/Q processor 79i to generate a receive input signal for a DFE (not shown in FIG. 4).

In the illustrated embodiment, the transmit I/Q processor 61i processes digital transmit data to generate I transmit data that is processed by an I-path of the transmitter 61i and Q transmit data that is processed by a Q-path of the transmitter 61i. The I-path upconverting mixer 83i and the Q-path upconverting mixer 84i provide frequency upconversion using quadrature transmit local oscillator (TX LO) clock signals from the PLLs 60i. After upconversion, the outputs of the I-path and the Q-paths are combined and attenuated as desired to generate the RF transmit signal provided to the RF front end 51.

With continuing reference to FIG. 4, the RF observation signal is attenuated as desired by the observation attenuator 91i, and thereafter processed by an I-path and a Q-path of the observation receiver 99i to generate a digital I observation signal and a digital Q observation signal. The observation I/Q processor 99i processes the digital I observation signal and the digital Q observation signal to generate digital observation data that can be used by the DFE for a variety of functions, such as transmit power control and/or DPD.

When connected to a DFE that provides blind source separation, the DFE is positioned after the ADCs 77i/78i in the receive chain. Thus, MIMO demultiplexing can occur at the full IQ sampling rate level (i.e., after the ADC in the Rx chain), thus improving communication latency. In contrast, SRS-based channel estimation and beamforming have a response time on the order of tens of milliseconds.

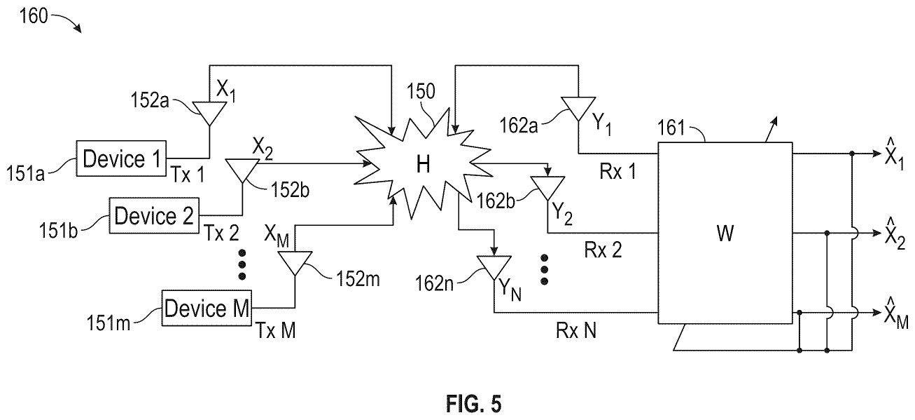

FIG. 5 is a schematic diagram of one embodiment of wireless communications network 160 using blind source separation. As shown in FIG. 5, multiple transmitting wireless devices 51a, 51b, . . . 51m transmit RF signals X₁, X₂, and X_{M} using transmitter channels Tx 1, Tx 2, . . . . Tx M and antennas 152a, 152b, . . . 152m, respectively. The transmitted RF signals X₁, X₂, and X_{M} are provided over a wireless channel 150 (providing a transformation H) to a wireless communications system.

Although each transmitting wireless device 51a, 51b, . . . 51m is shown in FIG. 5 as including one antenna, any of the transmitting wireless devices 51a, 51b, . . . 51m can include multiple antennas and/or one or more antenna arrays. For example, the transmitting wireless device 51a, 51b, . . . 51m can communicate using MIMO, in some implementations.

In the illustrated embodiment, the receiving wireless communications system includes antennas 162a, 162b, . . . 162n for receiving RF signals that are processed by receiver slices Rx 1, Rx 2, . . . Rx N, respectively, to generate input signals Y₁, Y₂, . . . Y_{N} (collectively referred to as an input signal matrix Y). The received input signals Y₁, Y₂, . . . Y_{N} are provided to a de-mixing matrix W of a DFE 161. The de-mixing matrix W is used to generate estimate signals \hat{X}₁, \hat{X}₂, . . . \hat{R}_{M} (collectively referred to as an output signal matrix \hat{X}) corresponding to respective estimates of X₁, X₂, and X_{M}. Thus, \hat{X}=WY and \hat{X} is an estimate of X.

The DFE 161 adapts coefficients of an adjustable weight matrix using blind source separation. The adjustable weight matrix can be used to determine the de-mixing matrix W. Thus, the wireless communications system of FIG. 5 can directly learn the de-mixing matrix W applied at the receiver. In certain implementations, independent component analysis (ICA) is used to iteratively obtain the coefficients of the adjustable weight matrix. Furthermore, such coefficients (and thus the recovery of X) can be obtained without needing to estimate and/or exchange CSI.

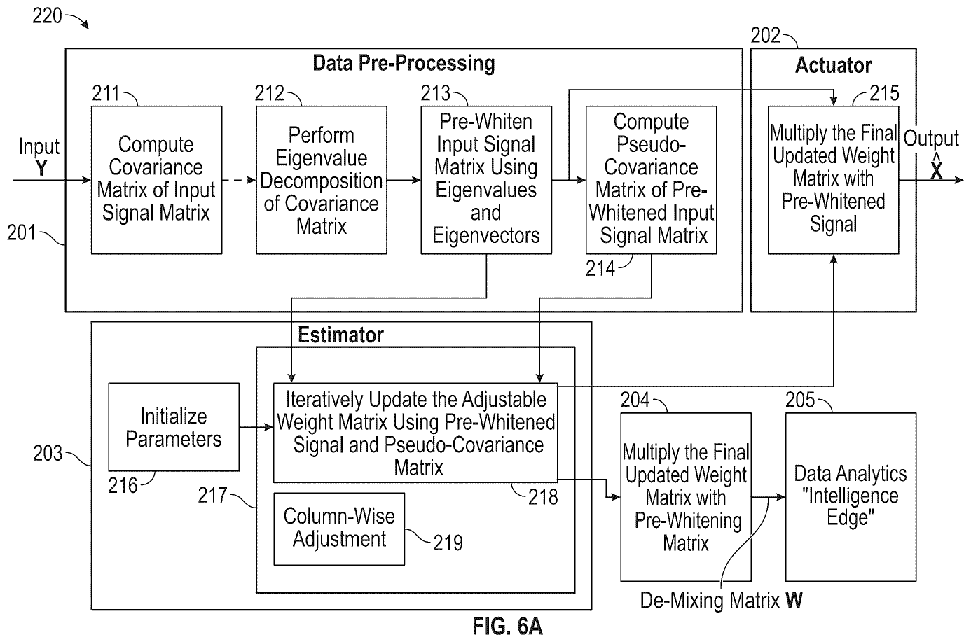

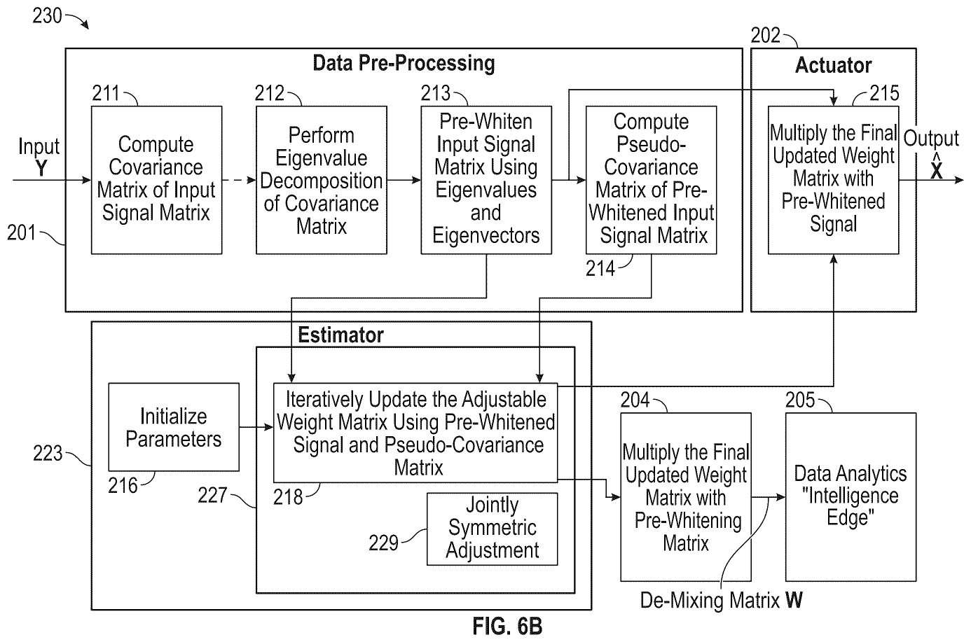

FIG. 6A is a schematic diagram of one embodiment of a DFE 220 for a wireless communications system. The DFE 220 includes a data pre-processing module 201, an actuator 202, an estimator 203, a de-mixing matrix generation module 204, and a data analytics module 205.

Although one embodiment of a DFE is shown in FIG. 6A, a DFE providing blind source separation can be implemented in other ways.

As shown in FIG. 6A, the data pre-processing module 201 receives the input matrix Y, which in one example is mathematically represented as Yϵ [symbol] ^{n×m}. Additionally, the data pre-processing module 201 includes a covariance matrix component 211 that computes a covariance matrix Φ of the input signal matrix Y. For example, in some implementations, the covariance matrix component 211 computes

$$Φ = \frac{1}{m} {\sum }_{i = 1}^{m} Y ( i ) {Y ( i )}^{H} .$$

With continuing reference to FIG. 6A, the data pre-processing module 201 further includes an eigenvalue decomposition component 212 that computes an eigenvalue decomposition of the covariance matrix, for instance, [V, Λ]=eig(Φ). Additionally, the eigenvalues and eigenvectors ([V, Λ]) can be processed by a pre-whitening component 213 to pre-whiten the input signal matrix Y. For example, in certain implementations, the pre-whitening component 213 generates a pre-whitened matrix Ω based on computing

$$Ω = V \cdot diag ( {Λ}^{\frac{- 1}{2}} ) .$$

Additionally, the pre-whitened matrix Ω can be used to generate a pre-whitened input matrix τ, for instance, based on computing τ=Y·Ω.

By providing pre-whitening in this manner, a linear transformation of the observed data is provided such that the elements are uncorrelated with unit variances.

In the illustrated embodiment, the data pre-processing module 201 further includes a pseudo-covariance component 214 for computing a pseudo co-variance of the pre-whitened input matrix τ. For example, in some implementations, the pseudo-covariance component 214 calculates a pseudo co-variance matrix ρ of the pre-whitened input matrix τ, for instance, based on computing

$$ρ = \frac{1}{m} {\sum }_{i = 1}^{m} τ ( i ) {τ ( i )}^{T} .$$

With continuing reference to FIG. 6A, the estimator 203 is used to iteratively adjust the adjustable weight matrix Π. As will be discussed further below, the final adjustable weight matrix Π (after iterative adjustments conclude) is used to generate the output signal matrix \hat{X}, which in one example is mathematically represented as \hat{X}ϵ [symbol] ^{n×m}.

As shown in FIG. 6A, the estimator 203 includes the initialization component 216 for initializing various parameters, such as the adjustable weight matrix Π as Iₘ and the output signal matrix \hat{X} as a zero matrix. For example, in some implementations, the initialization component 216 provides initialization by Π→ [symbol] ^{m×m} and → [symbol] ^{m×n}.

The estimator 203 also includes the matrix estimation component 217 that includes an iterative adjustment component 218 that iteratively updates the adjustable weight matrix Π based on a pre-whitened input matrix τ and the pseudo-covariance matrix ρ. For example, in some implementations, the iterative adjustment component 218 provides iterative adjustment to the adjustable weight matrix Π based on a fourth-order moment (kurtosis measure) using the pre-whitened input matrix τ and the pseudo-covariance matrix ρ until a stopping criteria (for instance, a stopping convergence threshold) is reached.

In this example, orthogonality is maintained using a column-wide adjustment component 219 that can, for example, apply sequential (e.g., Gram-Schmidt) processing.

With continuing reference to FIG. 6A, the actuator 202 includes the multiplication component 215 for generating the output matrix \hat{X} based on the pre-whitened input matrix t and the adjustable weight matrix Π. For example, in some implementations, the multiplication component 215 computes the output matrix \hat{X} as τΠ. In certain implementations, the output signal matrix \hat{X} is expressed with coefficients in polar form, for instance, as an amplitude and phase.

In certain implementations, the output of the blind source separation is expressed in terms of a combined system coefficient vector, and the kurtosis of the output signal can then be represented in the combined system coefficient space. For example, the kurtosis of the output signal can be represented as the sum of the kurtosis of each signal source, which can mathematically be represented as Σ_{i=sources}|ith system coefficient|⁴. In such implementations, kurtosis and power of the output signal only depend on amplitudes of system coefficients.

In some embodiments, the DFE 220 of FIG. 6A serves to maximize the objective function

$$\vert \frac{kurtosis}{power squared} \vert$$

subject to unit output power constraint, which can be implemented through pre-whitening. Additionally, the combined system coefficient amplitudes can be non-zero for the extracted source. Furthermore, for extracting multiple sources, resulting coefficient vectors can be constrained to be complex orthogonal.

As shown in FIG. 6A, the de-mixing matrix generation module 204 has been included for generating the de-mixing matrix W, which in one example is mathematically represented as Wϵ [symbol] ^{m×m}. In one example, the de-mixing matrix generation module 204 computes the de-mixing matrix W as ΩΠ. Although the de-mixing matrix W does not need to be directly calculated to determine the output matrix \hat{X}, the data analytics component 205 can use the de-mixing matrix W to infer signal characteristics (for instance, multipath, direct line of sight, etc.), propagation characteristics and/or to estimate the channel matrix.

FIG. 6B is a schematic diagram of another embodiment of a DFE 230 for a wireless communications system. The DFE 230 includes a data pre-processing module 201, an actuator 202, an estimator 223, a de-mixing matrix generation module 204, and a data analytics module 205.

The DFE 230 of FIG. 6B is similar to the DFE 220 of FIG. 6A, except that the DFE 230 of FIG. 6B includes the estimator 223 that includes a jointly symmetric adjustment component 229 for maintaining orthogonality.

With reference generally to FIGS. 6A and 6B, a DFE can include modules or components that are used to process input digital data representing a mixture signal of multiple transmitting sources to generate output digital data representing the estimated recovered signals using blind source separation. Such modules and/or components of the DFE can be implemented using data processing hardware (for example, digital processing circuitry and/or other hardware processing components) coupled to memory hardware storing instructions (also known as computer programs, software, software applications or code) that are executed by the data processing hardware to perform the corresponding operations.

Non-limiting examples of data processing hardware include central processing units (CPUs), configurable compute units (for example, field programmable gate arrays or FPGAs), digital signal processors (DSPs), neural processing units (NPUs), application specific integrated circuits (ASICs), custom digital circuits, semi-custom digital circuits, and/or any other suitable hardware processing components. Non-limiting examples of memory hardware include non-volatile memory, such as flash memory, read-only memory (ROM), programmable read-only memory (PROM), erasable programmable read-only memory (EPROM), and/or electronically erasable programmable read-only memory (EEPROM) as well as volatile memory, such as random-access memory (RAM), dynamic random-access memory (DRAM), static random-access memory (SRAM), and/or phase change memory (PCM).

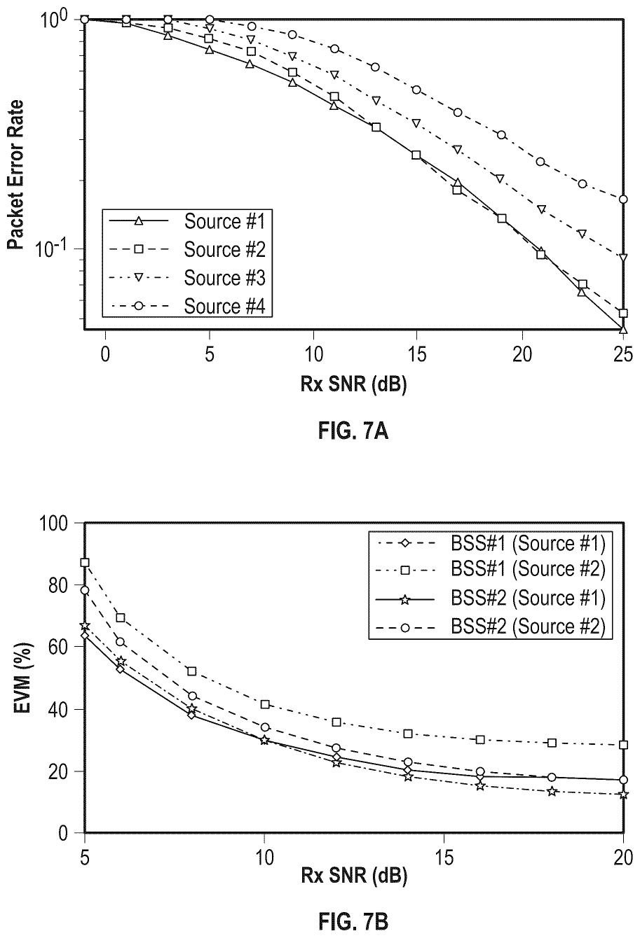

FIG. 7A is a graph of various examples of simulations of packet error rate (PER) versus receiver signal-to-noise ratio (SNR).

The graph depicts a simulation of four spatial streams that suffer from analog impairments. PER (without channel estimation and channel coding) is depicted for a case in which 4×4 MIMO is used to communicate the spatial streams. The blind source separation technique is robust for recovering the spatial streams, and the PER reduces as the receiver SNR increases.

FIG. 7B is a graph of various examples of simulations of error vector magnitude (EVM) versus received SNR. In this simulation, blind source separation is used to recover two signal sources that are modeled to include a doppler frequency shift, a time delay, and a magnitude attenuation. Plots are shown for recovering the two sources using one implementation of the DFE 620 of FIG. 6A (BSS #1) and using one implementation of the DFE 630 of FIG. 6B (BSS #2). The blind source separation technique is robust for recovering the spatial streams, and the EVM reduces as the receiver SNR increases.

### Applications

Devices employing the above-described schemes can be implemented into various electronic devices. Examples of electronic devices include, but are not limited to, RF communications systems, consumer electronic products, electronic test equipment, communication infrastructure, etc. For instance, a DFE providing blind source separation can be included in a wide range of wireless communications systems, including, but not limited to, radar systems, base stations, mobile devices (for instance, smartphones or handsets), phased array antenna systems, laptop computers, tablets, and/or wearable electronics.

### CONCLUSION

The foregoing description may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the figures depict example arrangements of elements and components, additional intervening elements, devices, features, or components may be present in an actual embodiment (assuming that the functionality of the depicted circuits is not adversely affected).

While certain embodiments have been described, these embodiments have been presented by way of example only and are not intended to limit the scope of the disclosure. Indeed, the novel apparatus, methods, and systems described herein may be embodied in a variety of other forms; furthermore, various omissions, substitutions, and changes in the form of the methods and systems described herein may be made without departing from the spirit of the disclosure. For example, while the disclosed embodiments are presented in a given arrangement, alternative embodiments may perform similar functionalities with different components and/or circuit topologies, and some elements may be deleted, moved, added, subdivided, combined, and/or modified. Each of these elements may be implemented in a variety of different ways. Any suitable combination of the elements and acts of the various embodiments described above can be combined to provide further embodiments.

What is claimed is:

1. A wireless communications system comprising:
a plurality of antennas configured to receive a plurality of radio frequency (RF) signals, the plurality of RF signals including a mixture of two or more transmitted signals received over a wireless channel from two or more transmitting devices; and
a digital front end (DFE) configured to receive a plurality of input signals corresponding to digital representations of the plurality of RF signals, wherein the DFE applies an adjustable weight matrix to the plurality of input signals to generate a plurality of output signals corresponding to estimates of the two or more transmitted signals, the DFE configured to determine a plurality of coefficients of the adjustable weight matrix by performing a blind source separation.

2. The wireless communications system of claim 1, wherein the DFE is configured to iteratively adjust the plurality of coefficients of the adjustable weight matrix.

3. The wireless communications system of claim 2, wherein the iterative adjustment is based on a kurtosis measure.

4. The wireless communications system of claim 1, wherein the DFE is configured to determine a covariance matrix of the plurality of input signals, and to perform an eigenvalue decomposition of the covariance matrix to determine a plurality of eigenvalues and eigenvectors, the DFE further configured to generate a pre-whitened input signal matrix based on the plurality of eigenvalues and eigenvectors.

5. The wireless communications system of claim 4, wherein the DFE is further configured to determine a pseudo-covariance matrix based on the pre-whitened input signal matrix, and to iteratively adjust the plurality of coefficients of the adjustable weight matrix based on the pre-whitened input signal matrix and the pseudo-covariance matrix.

6. The wireless communications system of claim 5, wherein the DFE is further configured to maintain an orthogonality of the adjustable weight matrix using at least one of a column-wise adjustment or a jointly symmetric adjustment.

7. The wireless communications system of claim 1, wherein the DFE is further configured to generate a pre-whitened matrix based on an eigenvalue decomposition of the plurality of input signals, and to generate a de-mixing matrix based on the adjustable weight matrix and the pre-whitened matrix.

8. The wireless communications system of claim 7, wherein the DFE includes a data analytics component configured to determine at least one of a channel propagation characteristic or an RF signal characteristics based on the de-mixing matrix.

9. The wireless communications system of claim 1, wherein the two or more transmitted signals have a common frequency sub-carrier.

10. The wireless communications system of claim 1, wherein the DFE is configured to obtain the estimates of the two or more transmitted signals without obtaining any channel state information (CSI) of the wireless channel.

11. The wireless communications system of claim 1, wherein the DFE is configured to provide equalization to the plurality of input signals to compensate for frequency selectivity prior to performing the blind source separation.

12. The wireless communications system of claim 1, wherein the two or more transmitted signals are associated with different wireless communications standards.

13. The wireless communications system of claim 1, wherein the plurality of antennas comprise a plurality of antenna arrays each operable to provide beamforming functionality to communicate with a cluster of transmitting devices.

14. A digital front end (DFE) for a wireless communications system, the digital front end comprising:
a data pre-processor configured to receive a plurality of input signals corresponding to digital representations of a plurality of RF signals, the plurality of RF signals including a mixture of two or more transmitted signals received over a wireless channel from two or more transmitting devices, the data pre-processor configured to process the plurality of input signals to generate a pre-whitened input signal matrix;
an estimator configured to determine a plurality of coefficients of an adjustable weight matrix based on the pre-whitened input signal matrix; and
an actuator configured to apply the adjustable weight matrix to the pre-whitened input signal matrix to generate a plurality of output signals corresponding to estimates of the two or more transmitted signals.

15. The DFE of claim 14, wherein the estimator is configured to iteratively adjust the plurality of coefficients of the adjustable weight matrix based on a kurtosis measure.

16. The DFE of claim 14, wherein the data pre-processor is configured to determine a covariance matrix of the plurality of input signals, and to perform an eigenvalue decomposition of the covariance matrix to determine a plurality of eigenvalues and eigenvectors, the data pre-processor further configured to generate the pre-whitened input signal matrix based on the plurality of eigenvalues and eigenvectors.

17. The DFE of claim 14, wherein the data pre-processor is further configured to determine a pseudo-covariance matrix based on the pre-whitened input signal matrix, the estimator configured to iteratively adjust the plurality of coefficients of the adjustable weight matrix based on the pre-whitened input signal matrix and the pseudo-covariance matrix.

18. The DFE of claim 17, wherein the estimator is further configured to maintain an orthogonality of the adjustable weight matrix using at least one of a column-wise adjustment or a jointly symmetric adjustment.

19. The DFE of claim 14, wherein the data pre-processor is further configured to generate the pre-whitened input signal matrix based on a pre-whitened matrix and to generate a de-mixing matrix based on the adjustable weight matrix and the pre-whitened matrix, the digital front end further comprising a data analytics component configured to determine at least one of a channel propagation characteristic or an RF signal characteristics based on the de-mixing matrix.

20. A method of wireless communications, the method comprising:
receiving a plurality of radio frequency (RF) signals on a plurality of antennas of a wireless communications system, the plurality of RF signals including a mixture of two or more transmitted signals received over a wireless channel from two or more transmitting devices;
processing the plurality of RF signals to generate a plurality of received signals corresponding to digital representations of the plurality of RF signals using a transceiver of the wireless communications system;
determining a plurality of coefficients of an adjustable weight matrix by performing a blind source separation using a digital front end (DFE) of the wireless communications system; and
applying the adjustable weight matrix to the plurality of received signals to generate a plurality of output signals using the DFE, the plurality of output signals corresponding to estimates of the two or more transmitted signals.
